(19) United States
(12) Patent Application Publication
(10) Pub. No.: US 2016/0021255 A1
(43) Pub. Date: Jan. 21, 2016

(54) SYSTEM AND METHOD FOR ACCESSING TELEPHONY SERVICES VIA AN APPLICATION PLUG-IN

(71) Applicant: VONAGE NETWORK LLC, Holmdel, NJ (US)

(72) Inventor: Kim Andrew Weldon, Atlanta, GA (US)

(21) Appl. No.: 14/333,666

(22) Filed: Jul. 17, 2014

(51) Int. Cl. H04M 7/00; H04W 4/16; H04W 12/06; H04M 3/42

(52) U.S. Cl. CPC H04M 7/003; H04M 3/42161; H04W 4/16; H04W 12/06

(57) ABSTRACT

Systems and methods for accessing telephony services via an application plug-in are provided herein. In some embodiments, a method for accessing telephony services via an application plug-in may include sending a first request to a telephony service provider system to authenticate a first user on a first device to access telephony service account features within an application using the application plug-in, receiving, via a user interface of the application plug-in, telephony service account configuration information, and sending, via the application plug-in, the telephony service account configuration information received to the telephony service provider system to update telephony service account configuration settings of the first user.

### FIELD OF THE INVENTION

The present invention relates to systems and methods for accessing click-to-call processing options and telephony account settings via a browser/application plug-in.

### BACKGROUND

Click to call is a service that allows a user who is viewing a web page to click a link on that web page to initiate a voice over Internet call. The link contains an embedded address (URL or IP address) that connects to a call server that allows for the setup and connection of the call. Typical click-to-call plug-ins in Web browsers may parse an HTML Web page, for example, recognize phone numbers, and re-render them to allow the phone numbers to be clicked or otherwise selected to initiate a phone call.

However, some telephony service browser plug-ins limit users to merely calling the selected phone number, without having options that the user would otherwise have available if making the call from a mobile or desktop app, such as a VoIP app on the user's mobile device. For example, the user cannot suggest a caller identifier to display on the device of a called party, or select from a plurality of phone numbers assigned to the user from which to designate as the calling number. In addition, the caller is unable to restrict websites that may be parsed and enabled for click-to-call, and unable to alter general telephony service account settings from the browser/application plug-in.

In view of the foregoing, there exists a need in the art for improved systems and methods and for accessing click-to-call options and general telephony account settings via a browser/application plug-in that allows for access to account-specific settings/call processing options directly from the plug-in itself without need to go to a specific webpage or account.

### SUMMARY OF THE INVENTION

Systems and methods for accessing telephony services via an application plug-in are provided herein. In some embodiments, a method for accessing telephony services via an application plug-in may include sending a first request to a telephony service provider system to authenticate a first user on a first device to access telephony service account features within an application using the application plug-in, receiving, via a user interface of the application plug-in, telephony service account configuration information, and sending, via the application plug-in, the telephony service account configuration information received to the telephony service provider system to update telephony service account configuration settings of the first user.

In some embodiments, a method for accessing telephony services via an application plug-in may include sending a first request to a telephony service provider system to authenticate a first user on a first device to access telephony service account features within an application using the application plug-in, receiving a first set of telephony service account settings associated with the first user from the telephony service provider system, receiving a selection of a selectable communication identifier displayed in the application to establish a telephone call from the first device to a second device associated with the selected communication identifier, and sending a second request to the telephony service provider system to establish the telephone call based on telephony service account settings associated with the first user.

In some embodiments, system for accessing telephony services may include an application installed on a computer system and configured to be executed by at least one processor of the computer system, an application plug-in added to the application to extend functionality of the application, wherein the application plug-in is configured to: send a first request to a telephony service provider system to authenticate a first user on a first device to access telephony service account features within an application using the application plug-in, receive, via a user interface of the application plug-in, telephony service account configuration information, and send, via the application plug-in, the telephony service account configuration information received to the telephony service provider system to update telephony service account configuration settings of the first user.

Other and further embodiments of the present invention are described below.

### BRIEF DESCRIPTION OF THE DRAWINGS

FIG. 1 depicts a block diagram of a telecommunication network, according to one or more embodiments of the invention.

FIG. 2 depicts a block diagram of a system for accessing telephony services via an application plug-in, according to one or more embodiments of the invention;

FIG. 3 depicts a flow diagram of a method for configuring user settings in a click-to-call communication, according to one or more embodiments of the invention;

FIG. 4 depicts a flow diagram of a method for configuring a telephonic call using a click-to-call communication, according to one or more embodiments of the invention;

FIG. 5 depicts an exemplary interface of a plug-in for accessing telephony services, according to one or more embodiments of the invention; and

FIG. 6 depicts a computer system that can be utilized in various embodiments of the present invention, according to one or more embodiments of the invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to systems and methods for accessing click-to-call processing options and telephony account settings via a browser/application plug-in. That is, the plug-in allows for access to account-specific settings/call processing options directly from the plug-in itself without need to go to a specific webpage or account. More specifically, the plug-in is provided in a web browser or application that may be used to authenticate a user to a service provider. Once authenticated, the user may utilize the plug-in to configure user settings such as preferred caller identifiers (call ID) and extensions from which to initiate a call. The plug-in may be used to disable click-to-call functionality within user specified websites. The user settings may be modified at any time. Once user settings are configured and stored on a service provider server, the user's configured settings can be used for making and receiving telephone calls from any device.

In order to enable click-to-call communications, the HTML code for the website is parsed and modified so as to re-render telephone numbers on the website to be clickable. In some embodiments, when a user clicks on a telephone number on a website, if the user has not been authenticated to the service provider server, the user is asked to enter authentication credentials, for example, a login and password. Upon successful authentication, a call box is displayed that may include the telephone number, a caller ID configured to be used with said telephone number. The selected telephone number and configured caller ID may be edited by the user. When the user opts to initiate the call, the call is initiated from the caller ID number to the telephone number. In addition, once the user is authenticated, other general telephony account configuration options may be accessed and changed.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

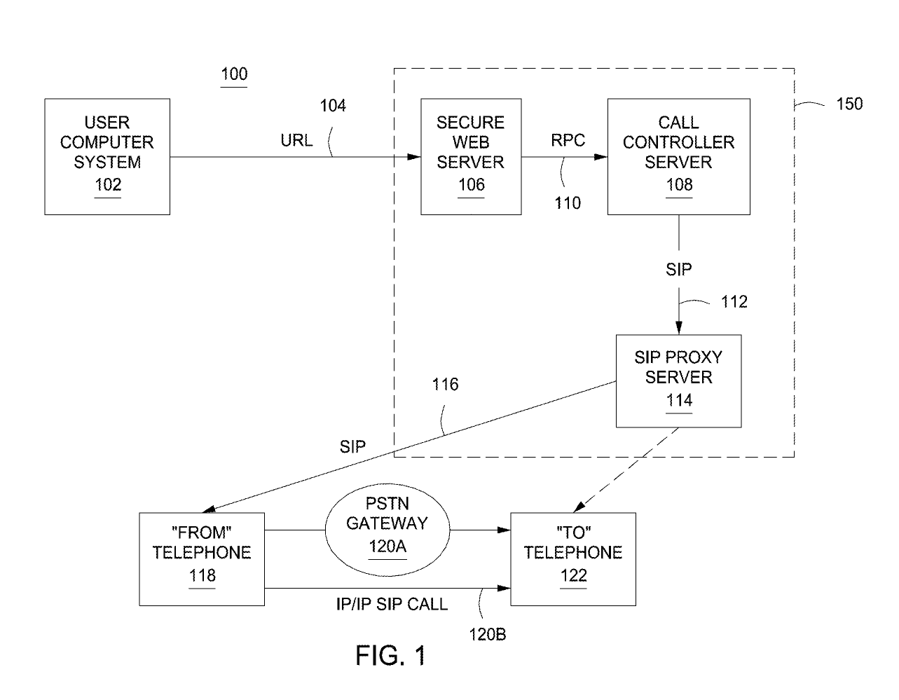

A system 100 in which at least some embodiments of the present invention may be implemented is shown in FIG. 1. The system 100 provides the capability for users to use a web browser or other Internet capable software to place a call, rather than using a keypad on a telephone (i.e., click-to-call functionality). In one embodiment, a web browser/application on a user computer system 102 is used to access the Internet and invoke a third party call control (3PCC) Application Programming Interface (API) provided by a telephony service provider system 150. In some embodiments, a hyper-text transfer protocol (HTTP) uniform resource locator (URL) 104 may be used to pass authorization credentials, such as login information if present, along with at least two phone numbers, a “from” number and a “to” number. The URL activates a secure web server 106, which authenticates the user and passes the information to a call controller server system 108. Preferably, the information is passed from secure web server 106 to call controller 108 using a Remote Procedure Call (RPC) 110. The call controller 108 is a trusted peer of Session Initiation Protocol (SIP) proxy server 114.

In some embodiments, when the user login information is not present or available, the plug-in may prompt the user to supply their telephony account login information via an authentication dialog box. The authentication dialog box displayed by plug-in may appear when the user launches the browser, when the user clicks on a selectable telephone number, or when the user clicks on the plug-in icon from the browser menu/chrome.

In response to receiving the RPC 110 from secure web server 106, call controller 108 invokes a number of methods via SIP signaling 112 involving SIP proxy server 114. The signaling 112 is a protocol for Internet conferencing, telephony, presence, events notification and instant messaging. SIP provides the necessary protocol mechanisms so that end systems and proxy servers can provide services such as call completion, call forwarding, callee and calling “number” delivery, personal mobility, terminal-type negotiation and selection, terminal capability negotiation, caller and callee authentication, blind and supervised call transfer, invitations to multicast conferences.

In response, SIP proxy server 114 invokes those methods via SIP signaling 116 to the appropriate target. In addition, SIP proxy server 114 monitors any calls that are initiated and completed, in order to handle the necessary billing functions.

In particular, call controller 108 initiates a call from call controller 108 to the “from” number 118, using a SIP INVITE method via signal 112. SIP proxy server 114, in turn, invokes the SIP INVITE method via signal 116 targeting the “from” telephone number 118. After the call is initiated from the call controller 108 to the “from” number 118, a call is then initiated from the “from” telephone number 118 to the “to” number 122. The technique used to invoke the SIP INVITE method between the “from” telephone 118 and the “to” telephone 122 depends upon the type of “from” telephone 118 involved. For example, if the “from” telephone 118 is an Internet Protocol (IP) telephone, the SIP INVITE 120B method to establish a call with the “from” telephone 118 and the “to” telephone 122 may be invoked directly on the “from” telephone 118, since the IP telephone is capable of performing the necessary functions in response to the invocation of the SIP INVITE method 120B. Alternatively, if the “from” telephone 118 is a standard Public Switched Telephone Network (PSTN) telephone, then the SIP INVITE method 120B to establish a call with the “from” telephone 118 and the “to” telephone 122 is invoked using a PSTN gateway server 120A to initiate the call. In either case, a call to the “from” telephone 118 is initiated.

When the “from” telephone 118 answers, call controller 108 initiates a call transfer to transfer the call to the “from” telephone 118 from the origin of the call, call controller 108, to the “to” telephone 122 number, using the SIP REFER method. This terminates the initial call between the call controller and the “from” telephone 118, and triggers the “from” telephone 118 to initiate a new call to the “to” telephone 122. This call is billed to the appropriate account.

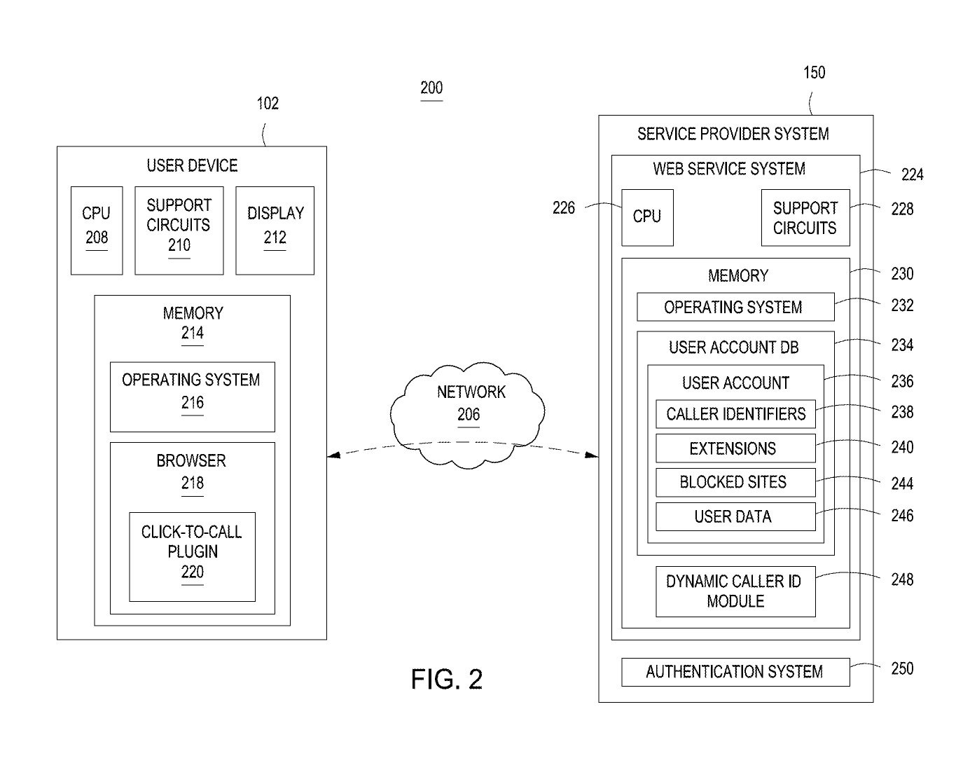

FIG. 2 depicts a block diagram of a system 200 for accessing click-to-call processing options and telephony account settings via a browser/application plug-in, according to one or more embodiments of the invention. The system 200 comprises a user device (e.g., user computer system 102) and a telephony service provider system 150 communicatively coupled via network 206.

The user device 102 is a computing device, such as a desktop computer, laptop, tablet computer, mobile device, and the like. The user device 102 may comprise a Central Processing Unit (CPU) 208, support circuits 210, a display 212, and a memory 214. The CPU 208 may comprise one or more commercially available microprocessors or microcontrollers that facilitate data processing and storage. The various support circuits 210 facilitate the operation of the CPU 208 and include one or more clock circuits, power supplies, cache, input/output device and circuits, and the like. The memory 214 comprises at least one of Read Only Memory (ROM), Random Access Memory (RAM), disk drive storage, optical storage, removable storage and/or the like. In some embodiments, the memory 214 comprises an operating system 216, and a browser 218 that includes a click-to-call plug-in 220 associated with service provider system 150. In some embodiments, the click-to-call browser plug-in 220 may be obtained via an application distribution platform such as GOOGLE PLAY or APPLE APPSTORE. The click-to-call plug-in 220 is configured to provide additional functionalities to the browser 218 (e.g., an add-on, plug-in, or extension) that facilitates dynamic caller ID functionality. As used herein, a plug-in (or plugin, extension, or add-on/addon) is a software component that adds a specific feature (e.g., telephony service features) to an existing software application. When an application supports plug-ins, it enables customization. The common examples are the plug-ins used in web browsers to add new features such as search-engines, virus scanners, or the ability to utilize a new file type such as a new video format. The click-to-call plug-in 220 may use the Netscape Plug-in Application Programming Interface (NPAPI), Pepper Plug-in API (PPAPI), or other type of plug-in/extension architecture to interface with the browser. Furthermore, although described herein in terms of a Web browser and Web browser plug-in, embodiments of the present invention may be used with any type of application that is capable of displaying content and accessing the internet. Thus, the term “browser” is intended to include any software, application, web tool, applet, plug-in and/or the like that can be used to render content for display. Examples of browser 218 may include, but are not limited to, FIREFOX®, GOOGLE® CHROME™, INTERNET EXPLORER®, OPERA™, SAFARI®, ANDROID® browser, FIREFOX® for mobile, INTERNET EXPLORER® Mobile, MICROSOFT EXCEL®, MICROSOFT WORD®, among others.

The operating system (OS) 216 generally manages various computer resources (e.g., network resources, file processors, and/or the like). The operating system 216 is configured to execute operations on one or more hardware and/or software modules, such as Network Interface Cards (NICs), hard disks, virtualization layers, firewalls and/or the like. Examples of the operating system 218 may include, but are not limited to, various versions of LINUX, MAC OSX, BSD, UNIX, MICROSOFT WINDOWS, 10S, ANDROID and the like.

The network 206 comprises one or more communication systems that connect computers by wire, cable, fiber optic and/or wireless link facilitated by various types of well-known network elements, such as hubs, switches, routers, and the like. The network 206 may include an Internet Protocol (IP) network, a public switched telephone network (PSTN), or other mobile communication networks, and may employ various well-known protocols to communicate information amongst the network resources.

In some embodiments, service provider system 150 may be a communication service provider, such as a VoIP service provider, that includes and maintains web service system 224 and authentication system 250. In other embodiments, the web service system 224 and authentication system 250 may be separate entities that provide web services and authentication services to service provider system 150, or to individual users, by agreement. Service provider system 150 may include web service system 224 that may be used to manage dynamic click-to-call functionality associated with a user, and an authentication system 250. The web service system 224 may include a Central Processing Unit (CPU) 226, support circuits 228, and memory 230. The CPU 226 may comprise one or more commercially available microprocessors or microcontrollers that facilitate data processing and storage. The various support circuits 228 facilitate the operation of the CPU 226 and include one or more clock circuits, power supplies, cache, input/output circuits, and the like. The memory 230 comprises at least one of Read Only Memory (ROM), Random Access Memory (RAM), disk drive storage, optical storage, removable storage and/or the like. In some embodiments, the memory 230 comprises an operating system 232, a user account database 234, and a dynamic caller ID module 248. The operating system (OS) 232 generally manages various computer resources (e.g., network resources, file processors, and/or the like). The operating system 232 is configured to execute operations on one or more hardware and/or software modules, such as Network Interface Cards (NICs), hard disks, virtualization layers, firewalls and/or the like. Examples of the operating system 232 may include, but are not limited to, various versions of LINUX, MAC OSX, BSD, UNIX, MICROSOFT WINDOWS, 10S, ANDROID and the like. The user account database 234 includes a plurality of user accounts 236. Each user account 236 includes one or more telephone

Although web service system 224 and authentication system 250 are shown as being included in the service provider system 150, those of ordinary skill in the art will recognize that one or more of these elements may be implemented as separate modules executed on remote network systems communicatively coupled to the user device 102 and the service provider system 150.

When a user opens the browser 218 that includes the click-to-call plug-in 220, a browser window opens that includes a toolbar. The toolbar includes an icon that provides access to features of a click-to-call service from a service provider, for example, a VoIP service provider. Clicking on the icon provides a list of options, for example, a login option, a set default caller ID option, a set default extension option, a set of blocked websites option, and the like. The login option provides a user interface that allows the user to log into the service provider system 150. The user may enter authentication credentials, such as a login and password. The authentication system 250 uses the credentials to authenticate the user. The authentication system 250 may use user data 246 to authenticate the user. User data 246 may include a user name, a user identifier, email address, other any information unique to the user. Once logged in, the user may configure one or more options associated with the click-to-call functionality or with the user's general telephony configuration settings. For example, the user may configure one or more caller IDs 238 by selecting an option provided by the click-to-call plug-in 220 that instructs the click-to-call plug-in 220 to retrieve a list of caller identifiers 238 stored in association with the user's account 236. This may be done via an HTTP request that includes the user's authorization credentials (login information) and returns the caller identifiers 238 associated with the user account 236 corresponding to that login information. The selected caller identifier 238 may be configured to be used with a telephone number, a category of telephone numbers, based for example, on area code, country code, and the like. The configured caller ID 238 is used as the initiating telephone number when the click-to-call communication is initiated.

Similarly, the user may access telephony configuration options and select from a plurality of extensions 240 associated with their account to direct incoming calls. For example, a user or business may have a main telephone number with multiple extensions. The user may be able to set the extension from the browser plug-in 220 which will then route/direct all calls to the user to the selected extension. Modifying their default extension is but one of any number of available account updates available from the Vonage Business account settings web server. In the context of the plug-in 220, an authenticated/logged-in user will generally have one designated “default” extension selected from one or more extensions that their account is authorized to use. In some embodiments, any time the user logs in or every time the user opens the settings interface, the plug-in 220 sends an HTTPS request to find the user's currently assigned extension. If the user has more than one extension, the plug-in 220 interface allows the user to select any available one to be their “extension” identity. In some embodiments, if for some reason the service provider system 150 has not marked the user's default extension, the plug-in 220 will attempt to make HTTPS request(s) to set the account default extension automatically. In some embodiments, the plug-in 220 will select the lowest numbered extension by default. For example, a user authorized to use extensions 515, 456, and 525 will be assigned extension 456 as active by default.

In addition to the telephony account settings that may be adjusted by the plug-in 220 described above, the plug-in 220 may adjust other web server based telephony account setting for which the account has access. For example, plug-in 220 may also access and change settings related to call-forwarding, sending calls straight to voice-mail, call hunt, SIMULRING (i.e., simultaneously ringing all the devices associated with the user until the user receives the call on one of the devices), and the like. Further telephony account feature support can include, but is limited to, “Account Directory Review”, dialing other extensions, call history search and display, call recording playback, text messaging settings, video call settings, and the like.

The user may also enter a list of “blocked sites” 244. Blocked sites 244 are websites where the click-to-call functionality is not enabled. Optionally, the user may disable click-to-call functionality for all websites. In some embodiments, the telephone identifiers are not made clickable for dialing. In some embodiments, the telephone identifiers are clickable, but should a user attempt to dial the telephone identifier, the user is notified that the call cannot be made.

After the user configures one or more options and the user is logged into the service provider system 150, all applicable configuration settings are active for the click-to-call service. The user may navigate to a website. The click-to-call module 220 identifies telephone identifiers (e.g., telephone numbers) on the website and modifies the HTML code to re-render the telephone identifiers such that the telephone identifiers may be clicked as is known in the art.

When the user clicks on a telephone identifier, a message is sent to the web service system 224. The message may be sent using a secure hyper-text transfer protocol (HTTPS). The message includes a user identifier for the user as well as the telephone identifier. The dynamic caller ID module 248 parses the message. Based on the telephone identifier, the dynamic caller ID module 248 identifies a caller ID 238 configured for the telephone identifier and an extension 240 from the user account 236. The configured caller ID 238 and extension 240 are sent to the click-to-call module 220. A call box is displayed that includes the telephone identifier. The call box may also include the Caller ID 238 that is configured for the telephone identifier as well as the selected extension 240, if any. The user may modify the telephone identifier, caller ID 238 or extension 240.

When the user selects to initiate the call, the click-to-call module 220 may then place a call using the telephone identifier as the “to” telephone number, using the configured caller ID 238 and extension 240 as the “from” telephone number. The click-to-call module 220 may place the call using the configured SIP proxy server 114 by invoking SIP INVITE methods 116, as discussed above.

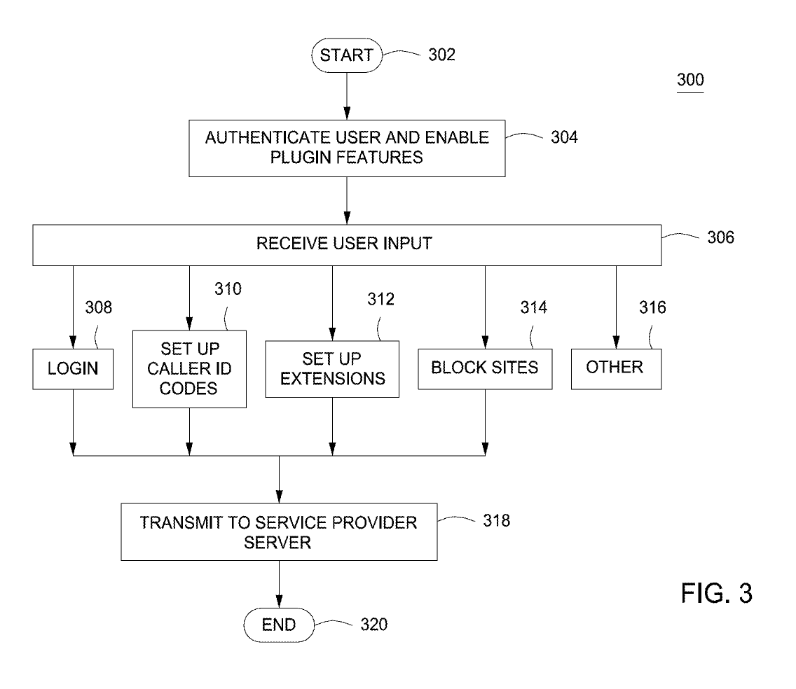

FIG. 3 depicts a flow diagram of a method 300 for configuring user settings in a click-to-call communication, according to one or more embodiments of the invention. The method 300 starts at step 302 and proceeds to step 304.

At step 304, a user is authenticated to access telephony service account features within a browser that includes a click-to-call plug-in. In some embodiments, the user may be authenticated when the browser is opened on a user's device. In other embodiments, the user may be authenticated when the user attempts to access a telephony service related feature, or when the user manually selects a login option provided by the click-to-call plug-in.

The plug-in may display an icon in the browser toolbar. The icon provides access to features of a click-to-call service from a service provider, for example, a VoIP service provider after a user is authenticated. Specifically, prior to activating telephony features of the click-to-call plug-in, a request is sent to a telephony service provider system to authenticate the user to access telephony service account features within an application using the click-to-call plug-in. After receiving an indication that the user was successfully authenticated, telephony service features (i.e., click-to-call features and telephony service account management) in the application are enabled.

At step 306, a user input is received. In some embodiments, the user input may be received by a user selection of an option from a pull down menu that is displayed when the icon is selected. In some embodiments, selecting the icon displays a plug-in from which other options may be selected.

If the user input is a selection to login to the service provider server, the method 300 proceeds to step 308. At step 308, a user interface is provided that allows the user to enter credentials that securely identifies the user to the service provider. The user credentials are sent via HTTPS to the service provider where an authentication system verifies the user, thereby enabling the user to configure user settings that may be used for click-to-call.

In some embodiments, the authentication processes at 304 and 308 use a token exchange procedure to allow a user to continually access the click-to-call features and telephony account management features even after the browser is shut down and reopened. Thus, the user essentially stays “logged in” for a predetermined/configurable period of time after the user is initially authenticated and provided an authenticated token. In some embodiments, when the authenticated token expires, the token may be refreshed and used to provide account access to the user without forcing the user to re-input their login information.

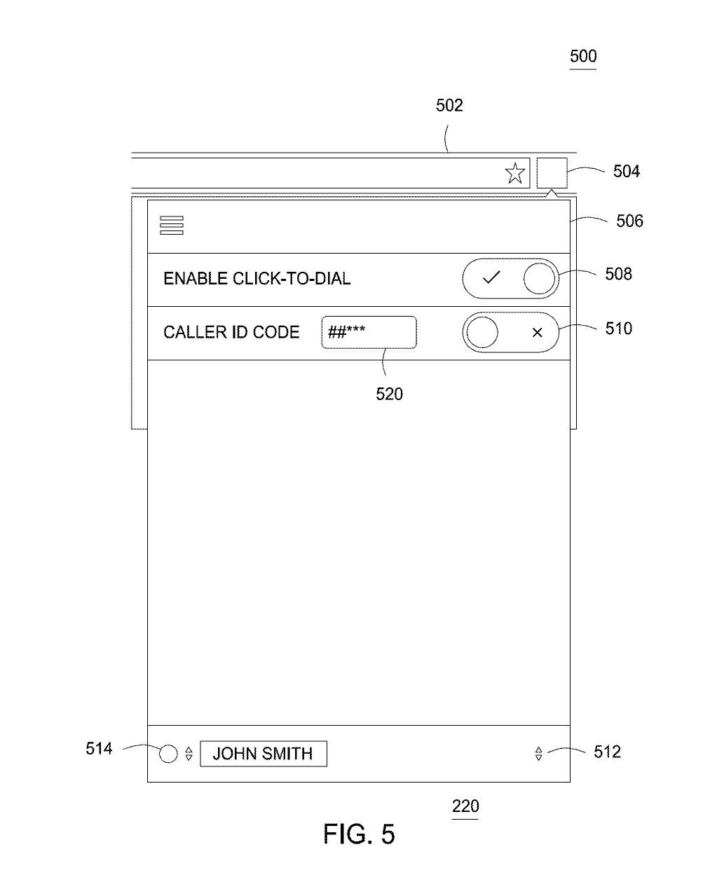

In some embodiments, if the user input at 306 is a selection to configure caller ID codes, the method 300 proceeds to step 310. For example, as shown in FIG. 5, a user may click on the plug-in icon 504 and access options screen 506 to set up caller ID codes 510. Specifically, FIG. 5 depicts a plug-in 220 for enabling dynamic caller ID in a click-to-call communication, according to one or more embodiments of the invention. The plug-in 220 is accessed from an icon 504 on a toolbar 502 of a website. Upon selection of the icon 504, a dropdown menu may be displayed. In the present display, an “Options” screen 506 is selected in order to configure user settings for dynamic caller ID in a click-to-call communication. The user may choose to Enable Click-to-call 508, set up Caller ID codes 510, or select an extension 512 to use when initiating a click-to-call communication. An indicator 514 shows that the user is logged in. The name of the user may be displayed next to the indicator. The indicator 514, when selected provides an option to log out the identified user.

Specifically, the Dynamic Caller ID features of plug-in 220 allows the user to enter Dynamic Caller ID codes in input box 520 that allow the user to access a richer feature set of calling options. The Dynamic Caller ID feature provides the ability to assign a “caller ID code” to any phone number on your account. Using the caller ID code, a user can make outbound calls from that particular number. For example, a user may configure different Direct Inward Dialing Numbers (DIDs) to route calls through. The DID may be specified in input box 520. In some embodiments, the codes input in input box 520 will be pre-populated as a prefix to the phone number selected to be dialed. Dynamic Caller ID feature is the ability to assign a “caller ID code” to any phone number on your account. Using the caller ID code, you can make calls from that particular number.

In some embodiments, if the user input at 306 is a selection to configure extensions, the method 300 proceeds to step 312. For example, as shown in FIG. 5, a user may click on the plug-in icon 504 and access options screen 506 to configure the user's extensions 512. As described above, the user may configure one of a plurality of extensions 240 associated with their account to direct incoming calls.

In some embodiments, if the user input at 306 is a selection to configure blocked sites, the method 300 proceeds to step 314. At step 314, a user interface is displayed in which the user may enter websites where click-to-call is to be disabled. Additionally, the user may navigate to any website and disable click-to-call from said website. For example, the user may right-click anywhere on the website and the plug-in displays a menu, with a selection such as “Add to Click-to-call Blocked Sites” or if the site is already blocked, “Remove from Click-to-call Blocked Sites”.

In some embodiments, the user input is a selection to configure other settings and the method 300 proceeds to step 316. For example, the user may select to logout of the service provider server or configure other settings. It is appreciated that although FIG. 3 illustrates five potential user inputs, other embodiments of the present disclosure envision additional possible user inputs.

The method 300 proceeds to step 318, where the configured information is transmitted to the service provider server for storage by the web service system. At step 320, the method 300 ends.

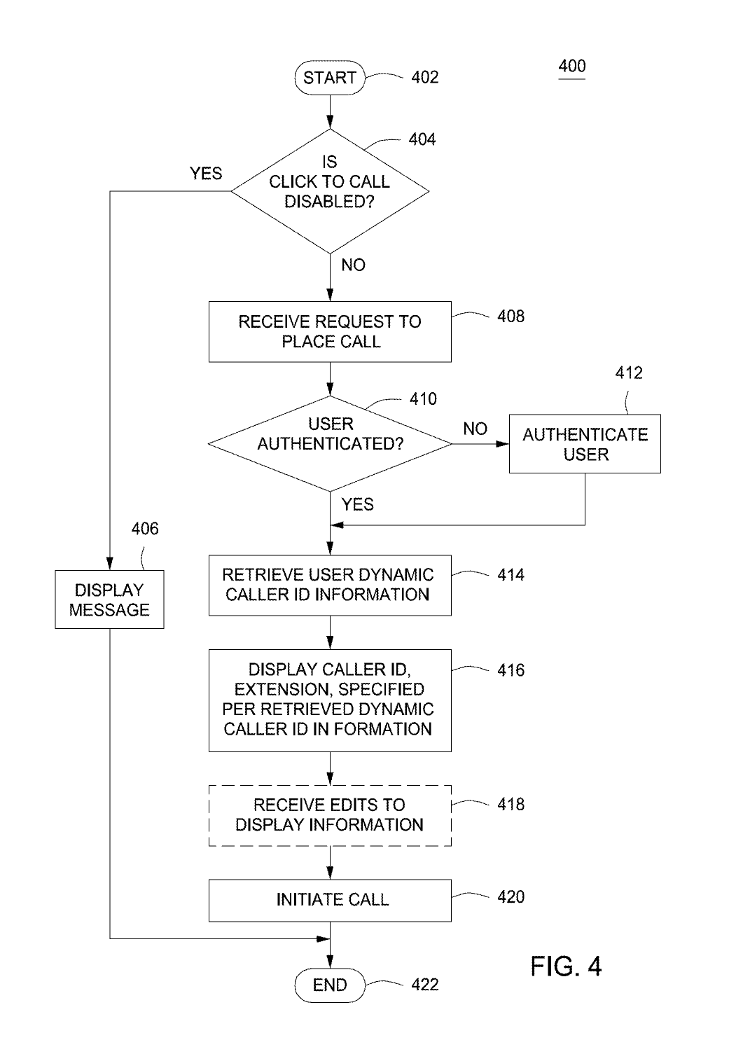

FIG. 4 depicts a flow diagram of a method 400 for configuring a telephonic call using a click-to-call communication, according to one or more embodiments of the invention. The method 400 starts at step 402 and proceeds to step 404.

At step 404, the URL of a website that a user navigates to is compared to a list of blocked/disabled websites. If click-to-call is blocked/disabled for that URL (i.e., the URL is on the blocked website list), or if the click-to-call feature is disabled for all websites, the method 400 proceeds to step 406 where a message is displayed that indicates that click-to-call is disabled and the method 400 proceeds to step 422.

If the click-to-call feature is enabled, and if the URL of the website that the user navigates to is not on the blocked list of websites, the website is processed/parsed and the communication identifiers (e.g., telephone numbers) on the website are identified. The HTML code that renders the website is modified in order to make the identified phone numbers clickable.

At 408, a request is received to place a call. In some embodiments, the request is received when a user clicks on a telephone identifier on a website. In some embodiments, the request is received by a entering a telephone identifier in a text box on a website, and selecting from for example a dropdown menu, an option to “Attempt Click-to-call”.

At step 410, it is determined whether the user is logged into a click-to-call service provider server. If the user is logged into the service provider server, the method 400 proceeds to step 414. However, if the user is not logged in, at step 412, a user interface is displayed that enables the user to enter credentials which are sent to the service provider server for authentication as described above with respect to steps 304 and 308 of FIG. 3. Upon successful verification by the server provider, the method 400 proceeds to step 414.

At step 414, dynamic caller ID information associated with the user is retrieved from the service provider server. The dynamic caller ID information may pre-pended to the selected telephone number (i.e., a communication identifier) when initiating a call to the telephone identifier. The dynamic caller ID information may include a list of blocked websites where Click-to-call is to be disabled.

At step 416, the telephone identifier that is to be called is displayed in a call box. In some embodiments, the configured caller ID and extension specified per the dynamic caller ID information retrieved from the service provider server are also displayed. At step 418, the user may optionally modify the telephone identifier, caller ID or extension.

At step 420, the call is initiated. The call is initiated from the number specified as the callerID and extension, and placed to the telephone identifier. The call is placed using the telephone identifier as the “to” telephone number, using the caller ID and extension as the “from” telephone number. The call may be place using a configured SIP proxy server by invoking SIP INVITE methods, as discussed above. The method 400 ends at step 422.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

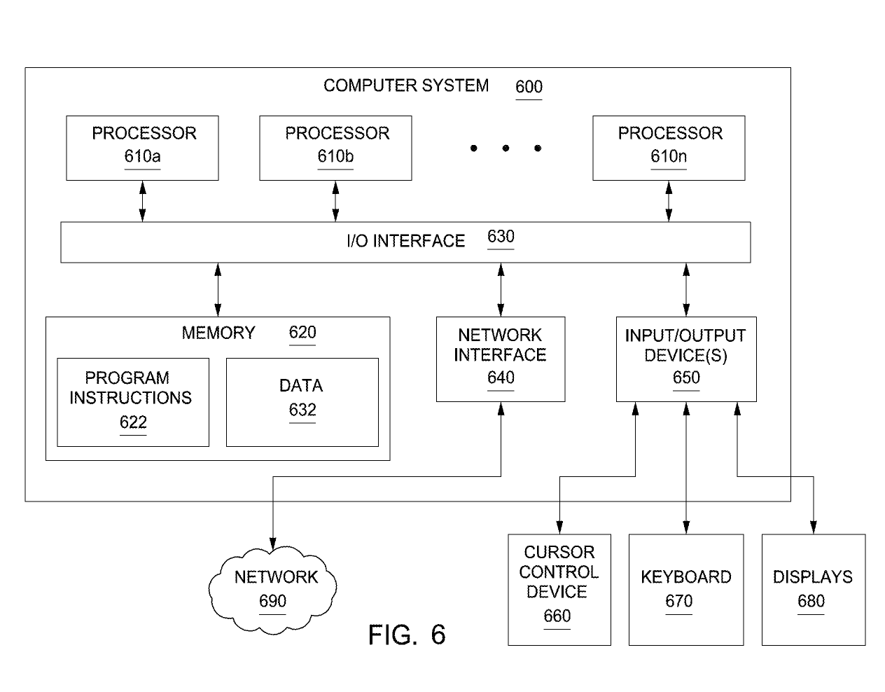

FIG. 6 depicts a computer system 600 that can be utilized in various embodiments of the present invention to implement the computer and/or the display, according to one or more embodiments.

Various embodiments of method and apparatus for organizing, displaying and accessing contacts in a contact list, as described herein, may be executed on one or more computer systems, which may interact with various other devices. One such computer system is computer system 600 illustrated by FIG. 6, which may in various embodiments implement any of the elements or functionality illustrated in FIGS. 1-5. In various embodiments, computer system 600 may be configured to implement methods described above. The computer system 600 may be used to implement any other system, device, element, functionality or method of the above-described embodiments. In the illustrated embodiments, computer system 600 may be configured to implement the methods 300 and 400 as processor-executable executable program instructions 622 (e.g., program instructions executable by processor(s) 610) in various embodiments.

In the illustrated embodiment, computer system 600 includes one or more processors 610a-610n coupled to a system memory 620 via an input/output (I/O) interface 630. Computer system 600 further includes a network interface 640 coupled to I/O interface 630, and one or more input/output devices 650, such as cursor control device 660, keyboard 670, and display(s) 680. In various embodiments, any of the components may be utilized by the system to receive user input described above. In various embodiments, a user interface may be generated and displayed on display 680. In some cases, it is contemplated that embodiments may be implemented using a single instance of computer system 600, while in other embodiments multiple such systems, or multiple nodes making up computer system 600, may be configured to host different portions or instances of various embodiments. For example, in one embodiment some elements may be implemented via one or more nodes of computer system 600 that are distinct from those nodes implementing other elements. In another example, multiple nodes may implement computer system 600 in a distributed manner.

In different embodiments, computer system 600 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 600 may be a uniprocessor system including one processor 610, or a multiprocessor system including several processors 610 (e.g., two, four, eight, or another suitable number). Processors 610 may be any suitable processor capable of executing instructions. For example, in various embodiments processors 610 may be general-purpose or embedded processors implementing any of a variety of instruction set architectures (ISAs). In multiprocessor systems, each of processors 610 may commonly, but not necessarily, implement the same ISA.

System memory 620 may be configured to store program instructions 622 and/or data 632 accessible by processor 610. In various embodiments, system memory 620 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 620. In other embodiments, program instructions and/or data may be received, sent or stored upon different types of computer-accessible media or on similar media separate from system memory 620 or computer system 600.

In one embodiment, I/O interface 630 may be configured to coordinate I/O traffic between processor 610, system memory 620, and any peripheral devices in the device, including network interface 640 or other peripheral interfaces, such as input/output devices 650. In some embodiments, I/O interface 630 may perform any necessary protocol, timing or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components, such as a north bridge and a south bridge, for example. Also, in some embodiments some or all of the functionality of I/O interface 630, such as an interface to system memory 620, may be incorporated directly into processor 610.

Network interface 640 may be configured to allow data to be exchanged between computer system 600 and other devices attached to a network (e.g., network 690), such as one or more external systems or between nodes of computer system 600. In various embodiments, network 690 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 640 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 650 may, in some embodiments, include one or more display terminals, keyboards, keypads, touchpads, scanning devices, voice or optical recognition devices, or any other devices suitable for entering or accessing data by one or more computer systems 600. Multiple input/output devices 650 may be present in computer system 600 or may be distributed on various nodes of computer system 600. In some embodiments, similar input/output devices may be separate from computer system 600 and may interact with one or more nodes of computer system 600 through a wired or wireless connection, such as over network interface 640.

In some embodiments, the illustrated computer system may implement any of the operations and methods described above, such as the methods illustrated by the flowcharts of FIG. 3 and FIG. 4. In other embodiments, different elements and data may be included.

Those skilled in the art will appreciate that computer system 600 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 600 may be transmitted to computer system 600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

What is claimed is:

1. A computer-implemented method for accessing telephony services via an application plug-in, comprising:
sending a first request to a telephony service provider system to authenticate a first user on a first device to access telephony service account features within an application using the application plug-in;
receiving, via a user interface of the application plug-in, telephony service account configuration information; and
sending, via the application plug-in, the telephony service account configuration information received to the telephony service provider system to update telephony service account configuration settings of the first user.

2. The computer-implemented method of claim 1, wherein the telephony service account configuration information received includes at least one of a dynamic caller ID code, a selection of an telephone extension to associate with incoming calls, one or more blocked Web sites, or a caller ID to associate with outgoing calls.

3. The computer-implemented method of claim 1, further comprising:
receiving an indication the first user was successfully authenticated; and
enabling telephony service features in the application responsive to receiving the indication.

4. The computer-implemented method of claim 3, wherein the telephony service features enabled include click-to-call features and telephony user account management features.

5. The computer-implemented method of claim 1, further comprising:
receiving a selection of a selectable communication identifier displayed in the application to establish a telephone call from the first device to a second device associated with the selected communication identifier; and
sending a second request to the telephony service provider system to establish the telephone call based on the telephony service account settings associated with the first user.

6. The computer-implemented method of claim 5, further comprising:
displaying the selected communication identifier to be called in a pop-up display object within the application.

7. The computer-implemented method of claim 1, wherein the application is a Web browser, and the application plug-in is a click-to-call telephony plug-in.

8. The computer-implemented method of claim 1, wherein the application plug-in interfaces with application a plug-in application programming interface.

9. A computer-implemented method for accessing telephony services via an application plug-in, comprising:
sending a first request to a telephony service provider system to authenticate a first user on a first device to access telephony service account features within an application using the application plug-in;
receiving a first set of telephony service account settings associated with the first user from the telephony service provider system;
receiving a selection of a selectable communication identifier displayed in the application to establish a telephone call from the first device to a second device associated with the selected communication identifier; and
sending a second request to the telephony service provider system to establish the telephone call based on telephony service account settings associated with the first user.

10. The computer-implemented method of claim 9, wherein the telephony service account settings received includes at least one of a dynamic caller identifier code, a selection of an telephone extension to associate with incoming calls, one or more blocked Web sites, or one or more caller identifiers to associate with outgoing calls.

11. The computer-implemented method of claim 10, further comprising:
displaying the selected communication identifier to be called in a pop-up display object within the application.

12. The computer-implemented method of claim 11, wherein the selected communication identifier is displayed in an editable text box.

13. The computer-implemented method of claim 11, wherein the selected communication identifier displayed in the pop-up display object is pre-pended with a dynamic caller identifier code included in the telephony service account settings associated with the first user.

14. The computer-implemented method of claim 11, wherein the selected communication identifier displayed in the pop-up display object is pre-pended with a dynamic caller identifier code included in the telephony service account settings associated with the first user.

15. The computer-implemented method of claim 9, further comprising:
receiving a selection of one of a plurality of caller identifiers associated with the first user with which to establish the telephone call to the second device.

16. The computer-implemented method of claim 9, wherein the first and second requests are sent using hyper-text transfer protocol (HTTP) or secure hyper-text transfer protocol (HTTPS).

17. The computer-implemented method of claim 9, further comprising modifying at least one of the communication identifier associated with the second device or one or more configured user settings prior to sending the second request to establish the telephone call.

18. The computer-implemented method of claim 9, wherein the application is a Web browser, and the application plug-in is a click-to-call telephony plug-in.

19. The computer-implemented method of claim 9, wherein the application plug-in interfaces with application a plug-in application programming interface.

20. A system for accessing telephony services, comprising:
an application installed on a computer system and configured to be executed by at least one processor of the computer system;
an application plug-in added to the application to extend functionality of the application, wherein the application plug-in is configured to:
send a first request to a telephony service provider system to authenticate a first user on a first device to access telephony service account features within an application using the application plug-in;
receive, via a user interface of the application plug-in, telephony service account configuration information; and
send, via the application plug-in, the telephony service account configuration information received to the telephony service provider system to update telephony service account configuration settings of the first user.

21. The system of claim 20, wherein the telephony service account configuration information includes at least one of a dynamic caller ID code, a selection of an telephone extension to associate with incoming calls, one or more blocked Web sites, or a caller ID to associate with outgoing calls.

22. The system of claim 20, wherein the application plug-in is further configured to:
receive an indication the first user was successfully authenticated; and
enable telephony service features in the application responsive to receiving the indication.

23. The system of claim 22, wherein the telephony service features enabled include click-to-call features and telephony user account management features.

24. The system of claim 20, wherein the application plug-in is further configured to:
receive a selection of a selectable communication identifier displayed in the application to establish a telephone call from the first device to a second device associated with the selected communication identifier; and
send a second request to the telephony service provider system to establish the telephone call based on the telephony service account settings associated with the first user.

25. The system of claim 20, wherein the application is a Web browser, and the application plug-in is a click-to-call telephony plug-in.

26. The system of claim 20, wherein the application plug-in interfaces with application a plug-in application programming interface.
